(19) United States
(12) Patent Application Publication
(10) Pub. No.: US 2013/0166458 A1
(43) Pub. Date: Jun. 27, 2013

(54) SYSTEM AND METHOD FOR REMOTE AND AUTOMATIC ASSESSMENT OF STRUCTURAL DAMAGE AND REPAIR

(71) Applicants: Cassio Wallner, Sao Jose dos Campos (BR); Paulo Anchieta da Silva, Sao Jose dos Campos (BR); Ricardo Rogulski, Sao Jose dos Campos (BR); Ricardo Pinheiro Rulli, Sao Jose dos Campos (BR); Tomaz Lazanha, Sao Jose dos Campos (BR)

(72) Inventors: Cassio Wallner, Sao Jose dos Campos (BR); Paulo Anchieta da Silva, Sao Jose dos Campos (BR); Ricardo Rogulski, Sao Jose dos Campos (BR); Ricardo Pinheiro Rulli, Sao Jose dos Campos (BR); Tomaz Lazanha, Sao Jose dos Campos (BR)

(73) Assignee: EMBRAER S.A., Sao Jose dos Campos (BR)

(21) Appl. No.: 13/335,268

(22) Filed: Dec. 22, 2011

(51) Int. Cl. G06Q 10/06

(52) U.S. Cl. 705/305

(57) ABSTRACT

Structural analysis automation allows the implementation of more detailed or accurate analysis methodology that reflects the actual behavior of the damaged or repaired structure and consequently improves the resulting damage disposition for example by Increasing the allowable damages and structural repairs applicability, increasing the allowable damage limits causing the reduction of unnecessary installation of structural repairs, optimizing repairs and increasing fly-by periods and inspection intervals.

### CROSS-REFERENCES TO RELATED APPLICATIONS

N/A

### STATEMENT REGARDING FEDERALLY SPONSORED RESEARCH OR DEVELOPMENT

N/A

### FIELD

The technology herein relates to systems (herein called “iSRM”) and methods for remote assessment of structural damage, repair and management of applicable maintenance information, and more particularly to such systems and methods for use with aircraft maintenance and repair.

### BACKGROUND AND SUMMARY

Aircraft in service are susceptible to corrosion, fatigue and accidental damages, which can be induced by service loads, environmental conditions or accidental impacts. These structural damages can be detected during a scheduled maintenance or during the aircraft operation (walkaround inspections). When the damage is detected through periodic scheduled inspection, usually the maintenance team has enough time to apply rework or repair procedures recommended by the aircraft manufacturer. On the other hand, when the damage is detected during the aircraft operation, the damage severity will determine whether the aircraft is in a condition for safe flight or whether it needs to be promptly removed from operation for repair.

Seeking safety improvement and reduction of maintenance cost and human error, efforts are underway to develop automatic SHM (Structural Health Monitoring) systems capable of inspecting and detecting damages in real time without need for human interference or attention. Therefore, new SHM technologies will lead to early detection of damage that usually in the past were identified only through scheduled inspections.

Once damage is detected during aircraft operation by means of the conventional inspection methods or through SHM systems, a technical team performs a prompt damage assessment, determining the damage severity and avoiding flight delay or cancellation whenever safely possible.

The effect of damage and repairs on the structural integrity of aeronautical structures is an aspect that should be evaluated in order to ensure the airworthiness and safe operation of the aircraft. FIG. 1 presents a flowchart of a prior art process currently used by the aircraft operators and manufacturers to assess the structural damages that occur during the aircraft life.

After damage detection, the Airline Technical Team performs the damage assessment based on SRM (Structural Repair Manual) instructions. Basically, the information contained in the SRM permits the operators to assess typical damages and restore the structural integrity of the aircraft by means of a simple rework or repair installation.

If the damage is within the limits specified in the SRM document, the airline reworks and/or repairs the aircraft in accordance with SRM instructions.

According to the damage severity, the aircraft may be returned to service without repair. This kind of allowable damage must have no significant effect on the strength or fatigue life of the structure, which must still be capable of fulfilling its design function. Allowable damage may be contingent upon minimal rework, such as blend-out, cleanup or plugging a hole. Depending on its severity, some damages are allowed only for a specific period, called “fly-by period”, in which during a number of flight cycles the aircraft can fly with the damage prior to repair. For more severe typical damage, the SRM contains sufficient information to enable the operator to carry out permissible repairs.

On the other hand, when the damage is not within the limits specified in the SRM or not covered by manual, the damage is evaluated by the aircraft manufacturer. An OEM Technical Team performs damage assessment based on structural analysis and engineering judgment and a specific rework or repair design will be developed or evaluated. Finally, the airline reworks or/and repairs the aircraft in accordance with manufacturer instructions.

There are some inefficiencies in the process presented above, such as the long time spent by the airline technical team consulting the SRM and assessing the damage based on its instructions. Additionally, due to human factors, mistakes can occur during this activity resulting in an incorrect damage disposition.

For cases in which the structural damage is not covered by the SRM, the airline contacts the aircraft manufacturer to evaluate the effect of damage or/and repair on the aircraft structural integrity and provide a specific disposition. Measurement of structural integrity degradation can be a complex task. The use of detailed structural analysis methodology usually demands a long time and, due to this fact, it becomes impractical for the aeronautical industry. Generally, simplifications are adopted for safety reasons which can lead to conservative analysis resulting in for example:
Limited applicability of allowable damages and structural repairs;
Reduced allowable damage limits causing unnecessary installation of structural repairs;
Over dimensioned repairs;
Flight delays and cancellations;
Reduced inspection intervals that increase aircraft maintenance costs.

One prior method currently used to assess the structural damage, requires that the airline technical team consults the SRM and assesses the damage based on its instructions. There can be issues in this process, such as the long time spent by the airline technical team during this activity and the mistakes that can occur, due to human factors, resulting in an incorrect damage disposition. Besides that, some prior systems do not perform structural analysis in order to improve the damage disposition or provide a rework and/or repair solution when the damage is not within the limits specified in the SRM.

Another prior system uses an image of damaged structure as its primary input data and performs structural analysis without any previous verification if the damage is already covered by SRM and the disposition obtained based on the already issued SRM satisfy the operator needs. In addition, some systems do not generate a structural analysis report containing information of the accomplished analyses in order to substantiate the damage disposition.

A computerized and automated system specially developed in order to assess typical structural damages and repairs will lead to cost and safety benefits. The structural analysis automation allows the implementation of more detailed and accurate analysis methodology that reflects the actual behavior of the damaged or repaired structure and consequently improves the damage disposition.

The exemplary illustrative non-limiting technology herein consists of a system (herein called “iSRM”) and a method for remote assessment of structural damage, repair and management of the applicable maintenance information.

The exemplary illustrative non-limiting iSRM (intelligent Structural Repair Management) system is able to provide electronic disposition for structural damage that occurs during the aircraft life. Also, this web application system is responsible for storage and management of the aircraft damage and repair information.

Using the system graphic interface via Web, Local Network and/or Local Computer, the Airline Technical Team can identify and register all structural damages, including allowable damage, fly-by, temporary repair and permanent repair. The graphic interface provides to the user a three-dimensional aircraft model (3D digital mock-up), enabling smooth navigation between different aircraft parts and enabling identification of the damaged location on the aircraft.

The management and traceability of the structural damages and repairs enable the Airline Technical Team to identify aircraft field issues and to control the damages and repairs life cycles, e.g., to provide benefits of management and traceability to the operators.

### BRIEF DESCRIPTION OF THE DRAWINGS

These and other features and advantages will be better and more completely understood by referring to the following detailed description of exemplary non-limiting illustrative embodiments in conjunction with the drawings of which:

FIG. 1 is a flowchart of a prior art process currently used to assess the structural damage;

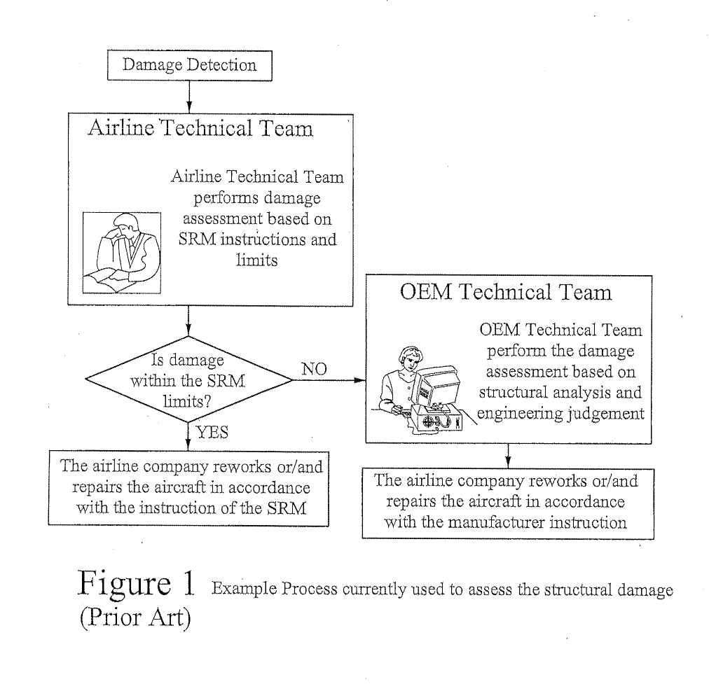

FIG. 2 is a schematic diagram of an exemplary illustrative non-limiting iSRM Damage Assessment system;

FIG. 3 is a flowchart of an exemplary illustrative non-limiting iSRM Damage Assessment Process; and

FIG. 4 is a flowchart of an exemplary illustrative non-limiting iSRM Damage Assessment Process without the report approval sub-process.

### DETAILED DESCRIPTION

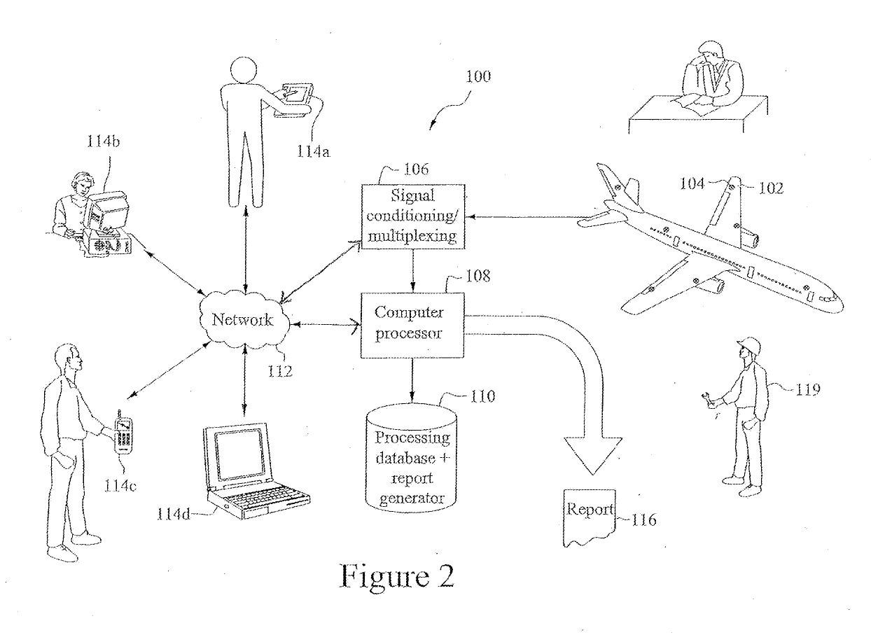

FIG. 2 shows an example non-limiting iSRM damage assessment system 100. As shown in FIG. 2, an aircraft 102 can be equipped with or otherwise inspected by a variety of sensors 104 to automatically detect structural or other damage. The damage can also be detected other than by automatically. For instance, damage can be detected visually (walkaround inspection). In such case, damage information can be provided by the Airline Technical Team to iSRM manually, using the iSRM interface (e.g., via an input device 114). For example, in one example non-limiting implementation, sensors 104 provide signals of various forms including but not limited to electrical signals related to the structural condition to a signal conditioning/multiplexing device 106 that in turn provides sensed signals to a computer processor 108. Signal conditioning/multiplexing block 106 may also receive additional manual or other inputs via network 112, or such additional inputs can be provided directly to computer processor 108 via a user interface that may be directly connected to the computer processor or indirectly connected e.g., via network 112. For example, the user may provide information on the damage detected (by various means) and, using the 3d model, he identifies the location of the damage.

Computer processor 108 uses software and data stored on a non-transitory storage device such as a disk drive, flash memory, etc. 110 to analyze the signals from sensors 104 as well as potentially other information inputs in order to detect whether the aircraft 102 has sustained damage. If damage has been sustained, then computer processor 108 can use automatic and/or human-assisted algorithms to assess the severity of the damage e.g. based on a flight history or other database stored on storage device 110.

Computer processor 108 may communicate alerts, reports, or other information via a wired and/or wireless network 112 to a variety of user interaction devices 114 included but not limited to laptop computers, smart phones, tablet computers, other personal computers or any other device that allows interactivity between humans and machines. Computer processor 108 may generate electronic, hardcopy or other reports 116 and transmit them for review by various people including service personnel 118, the manufacturer of the aircraft 102, the pilot of the aircraft, and others. It may also use software to maintain a 3D model of the particular aircraft, and render and display images on demand that enable smooth interactive navigation and display by the user between different aircraft parts and also enable identification of damaged locations of the aircraft. The example non-limiting system can further automatically enable users to manage damages, repairs and maintenance information comprising, but not limited to, providing visualization and generating reports for damages and repairs per aircraft and/or per fleet, and communicating alerts on inspection intervals for repair location.

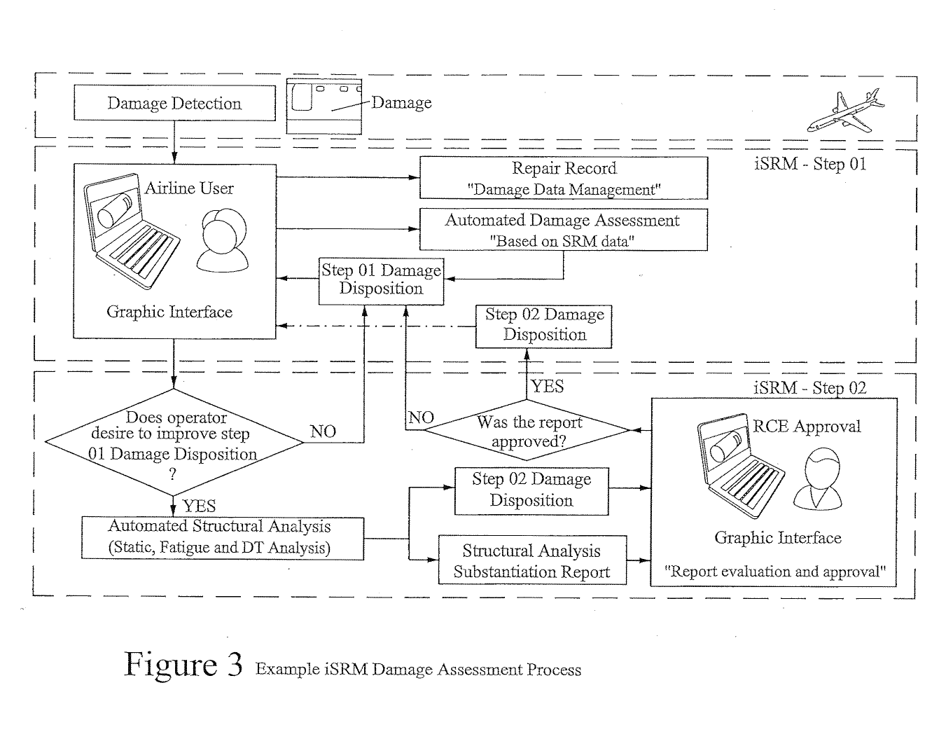

The FIG. 3 is a flow chart of an example non-limiting damage assessment process implemented in an example iSRM system:

First, the damage is detected by means of conventional inspection methods and sensors 104 including for example visual and/or NDI (Non-Destructive Inspection, such as Eddy Current, X-Ray, Die Penetrant, Ultrasound, etc.), through SHM systems, such as acoustic emission system, CVM (Comparative Vacuum Monitoring) system, Lamb waves system, electro-mechanical impedance system, optical sensors and other sensors.

Using the system graphic interface via Web, Local Network 117 and/or Local Computer 114a, the Airline Technical Team characterizes the damage detected in the aircraft structure supplying damage information such as dimensions, damage type, location, affected areas, etc.

The system will assess the damage based on the damage information supplied by the user and the structural properties from the aircraft selected part in the 3D model and suggest an appropriate damage disposition. This analysis shall result in an allowable damage, fly-by, temporary repair, permanent repair or contact manufacturer for specific disposition.

As shown in FIG. 3, the damage assessment is performed automatically by the system in one or two STEPS. In the first STEP, the damage disposition will be provided based on the already issued Structural Repair Manual (SRM). The system will compare the damage information supplied by the user with the limits specified in the SRM. Since the assessment will be made automatically by the system without human interference, the mistakes that nowadays can occur during SRM consultation will be reduced and during damage assessment based on its instructions will be eliminated.

Besides the disposition obtained in the first STEP, in case it is deemed necessary, it is possible to request a dedicated damage assessment. During this second STEP, the system will perform specific structural analysis in order to improve damage disposition. Based on engineering criteria and structural analysis, the system will perform a specific assessment for the detected damage considering several parameters such as damage type, geometry and dimensions of affected areas, material parameters, structure loads and so on.

In order to comply with applicable aeronautical requirements and substantiate the structural damage disposition in metallic or composite parts, the system will perform several structural analyses including but not limited to, when applicable, static analysis, fatigue analysis and damage tolerance analysis.

When applicable, based on several failure criteria (tensile, compression, buckling and post-buckling, crippling, durability, etc), a specific static analysis or/and fatigue analysis or/and damage tolerance analysis will be performed in order to evaluate the behavior of the damaged or repaired structure under static and cyclic loading (load spectrum).

Besides the repair or rework procedure, the system will provide, when applicable, the number of flight cycles allowed before the repair installation and the new inspection intervals for repair location. When applicable, during the damage tolerance analysis, a specific crack propagation analysis or damage growth analysis will be performed aiming to increase the fly-by period or inspection intervals obtained in the first STEP.

After completing the automated structural analysis, the system will generate a structural analysis substantiation report 116 containing information of the accomplished analyses and submit it for DER (Delegated Engineering Representative) evaluation and approval. Once the report is approved by DER, the damage disposition will be promptly made available to the airline for aircraft repair.

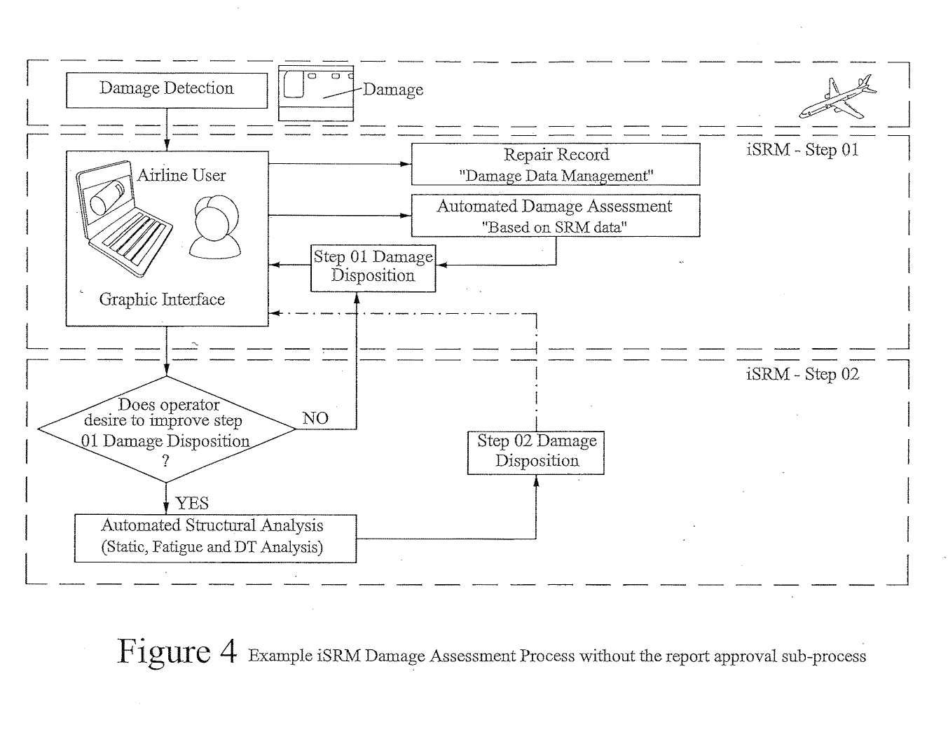

The report approval process will be necessary during the initial period until the certification authority has enough confidence in the system output or disposition. The FIG. 4 presents a flow chart of an example non-limiting iSRM damage assessment process without the report approval sub-process:

Based on all aspects explained above, besides the optimization of the manufacturer engineering man-power, the structural analysis automation allows the implementation of more detailed or accurate analysis methodology that reflects the actual behavior of the damaged or repaired structure and consequently improves the resulting damage disposition for example as follows:
Increase of the allowable damages and structural repairs applicability;
Increase of the allowable damage limits causing the reduction of unnecessary installation of structural repairs;
Optimized repairs;
Increase of the fly-by periods and inspection intervals.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

1. A method, implemented at least in part by at least one computer including a processor, a display and a storage device, of assessing structural damage to an aircraft, the method comprising:
detecting damage to an aircraft;
characterizing the detected damage;
automatically with the processor, assessing the characterized detected damage and structural properties;
automatically with the processor, suggesting a damage disposition; and
automatically, with the processor, enabling a user to manage structural damage, repairs and maintenance information.

2. The method of claim 1 wherein the damage disposition includes allowable damage, fly-by, temporary repair, permanent repair, and/or contacting the aircraft manufacturer for specific disposition.

3. The method of claim 1 further including using the processor to test for at least one of static, fatigue and damage tolerance structural analysis.

4. The method of claim 1 further including generating a damage report; and conditioned on approval of said damage report via a network, automatically by computer generating at least one maintenance or repair instruction.

5. The method of claim 1 further including generating the damage disposition by automatically comparing assessed damage to a Structural Repair Manual.

6. The method of claim 1 further including requesting a dedicated damage assessment performing specific structural analysis.

7. The method of claim 6 wherein the dedicated damage assessment uses several parameters including damage type, geometry and dimensions of affected areas, material parameters and structural loads.

8. The method of claim 6 further including performing a static and/or fatigue analysis based on tensile, compression, buckling, post-buckling, crippling and/or durability failure criteria.

9. The method of claim 1 further including automatically providing the number of flight cycles allowed before the repair installation.

10. The method of claim 1 further including automatically providing new inspection intervals for repair location.

11. The method of claim 6 further including performing a crack propagation and/or damage growth analysis.

12. The method of claim 1 further including management of damages, repairs and maintenance information comprising, but not limited to, providing visualization and generating reports for damages and repairs per aircraft and/or per fleet, and communicating alerts on inspection intervals for repair location.

13. A system for assessing structural damage to an aircraft comprising:
at least one input arrangement that provides input concerning damage to the aircraft;
at least one computer coupled to the input arrangement, the at least one computer including a processor, a display and a storage device;
automatically with the processor, assessing the characterized detected damage and structural properties; automatically suggesting a damage disposition; and automatically, with the processor, enabling structural damages, repairs and maintenance information management.

14. The system of claim 13 wherein the damage disposition includes allowable damage, fly-by, temporary repair, permanent repair, or contact the aircraft manufacturer for specific disposition.

15. The system of claim 13 wherein the processor automatically performs automated structural analysis to test for at least one of static, fatigue and damage tolerance analysis.

16. The system of claim 13 wherein the processor automatically generates a damage report; and conditioned on approval of said damage report, automatically generates at least one maintenance or repair instruction.

17. The system of claim 13 wherein the processor generates the damage disposition by automatically comparing assessed damage to a Structural Repair Manual.

18. The system of claim 13 wherein the processor provides a dedicated damage assessment by performing specific structural analysis.

19. The system of claim 18 wherein the damage assessment uses several parameters including damage type, geometry and dimensions of affected areas, material parameters and structural loads.

20. The system of claim 18 wherein the processor performs a static and/or fatigue analysis based on tensile, compression, buckling, post-buckling, crippling and/or durability failure criteria.

21. The system of claim 13 wherein the processor automatically provides the number of flight cycles allowed before the repair installation.

22. The system of claim 13 wherein the processor automatically provides new inspection intervals for repair location.

23. The system of claim 18 wherein the processor automatically performs a crack propagation and/or damage growth analysis.

24. The system of claim 13 wherein the processor allows management of damages, repairs and maintenance information comprising, but not limited to, providing visualization and generating reports for damages and repairs per aircraft and/or per fleet, and communicating alerts on inspection intervals for repair location.

25. In a system for assessing structural damage to an aircraft, a non-transitory storage device for use with at least one computer coupled to sensors, the at least one computer including a processor, a display and a storage device, the storage device storing instructions that when executed by the at least one processor:
non-destructively detects damage to the aircraft in response to outputs from the sensors;
characterizes the detected damage,
assesses the characterized detected damage and structural properties; and
suggests a damage disposition.

26. The method of claim 1 wherein the sensor detects at least one of visual, Eddy Current, X-Ray, Die Penetrant, Ultrasound, acoustic emission, Comparative Vacuum, Lamb waves, electro-mechanical impedance and optical.

27. The method of claim 1 wherein the damage characterizing uses automatic and/or human-assisted algorithms to assess the severity of the damage based on a flight history or other database stored on a storage device coupled to the processor.

28. The method of claim 1, wherein said detecting damage comprises using a sensor coupled to the processor to automatically detect damage.

29. The system of claim 13, wherein the at least one input arrangement comprises at least one sensor that automatically detects aircraft damage.
